(19) United States
(12) Patent Application Publication
(10) Pub. No.: US 2008/0220227 A1
(43) Pub. Date: Sep. 11, 2008

(54) Coated printing stock for use as labels and the like

(76) Inventors: Cecil M. Keeney, Metairie, LA (US); Bernard E. Pemberton, Rockville, MD (US); James D. Combs, Winchester, KY (US); Gregory L. Brown, Cadiz, KY (US)

Correspondence Address: KING & SCHICKLI, PLLC, 247 NORTH BROADWAY, LEXINGTON, KY, 40507, US

(21) Appl. No.: 11/502,083

(22) Filed: Aug. 10, 2006

Related U.S. Application Data
(63) Continuation-in-part of application No. 11/442,792, filed on May 30, 2006.

(51) Int. Cl. B32B 3/10

(52) U.S. Cl. 428/203

(57) ABSTRACT

A label incorporates slip agent and antistat directly into the polymer layers from which the label is constructed.

This application is a continuation-in-part of U.S. patent application Ser. No. 11/442,792 filed 30 May 2006.

### TECHNICAL FIELD

The present invention relates generally to the product labeling and packaging fields and, more particularly, to a sheet of printing stock coated on both faces with an antistatic formulation.

### BACKGROUND OF THE INVENTION

Cut and stack labels have long been used on glass bottles, cans and plastic containers. Currently, there is a growing consumer preference for food, beverage and household products packaged in plastic containers. This is because plastic containers offer the consumer a number of convenient benefits including, but not limited to, portability, resealability, safety, light weight and contourability for a comfortable grip.

Plastic containers, however, pose several challenges for packaged goods companies and label manufacturers. One of the main reasons for this is that plastic containers are particularly durable and can withstand more demanding consumer environments, such as an ice chest, as well as withstand a drop to the ground of perhaps six feet or more. Further, a plastic container's portability means it can be used and the product consumed over a long period of time including days or weeks.

For label manufacturers, this means packaged goods companies prefer labels to be 100% waterproof, 100% scuff-proof, extremely durable, resistant to scuffing and product deterioration, able to withstand drops of six feet or more without tearing and be aesthetically pleasing to the consumer's eye and touch for the life of the use of the plastic container. Unfortunately, no state of the art label capable of use with existing cut and stack labeling equipment offers all of these desired performance features in the absence of added offset powder and antistat.

State of the art label solutions for plastic containers generally fall into four categories: poly/paper, aqueous coated synthetic, ultraviolet (UV) coated synthetic and poly/poly. An example of a state of the art poly/paper label is a lightweight clear polypropylene film laminated to C1S paper. The clear polypropylene film provides an attractive high gloss appearance. The film lamination also provides durability for scuff protection and passing drop tests. Due to its incorporation of a paper layer, however, the poly/paper label is not waterproof. Accordingly, when subjected to humid or wet environments, the label has a tendency to curl and/or to deteriorate.

An example of an aqueous coated synthetic label is a single layer heavyweight bright white polypropylene film that is aqueous coated. The 100% film nature of the construction provides the label with 100% waterproof properties. However, an aqueous coated synthetic label does not have the high gloss appearance or excellent scuff resistance properties of laminated labels and, accordingly, does not provide a complete answer to the needs of the packaged goods manufacturer.

An example of a UV coated synthetic label is a single layer of heavyweight bright white polypropylene film printing stock that is ultraviolet coated. Again, the 100% film nature of the construction provides the label with 100% waterproof properties. While the UV coated synthetic label does have a higher gloss appearance and improved scuff and product resistance properties when compared to an aqueous coated synthetic label due to the use of an ultraviolet coating, it does not offer the same degree of gloss and scuff protection as the film lamination label. This shortcoming along with the high cost of ultraviolet inks and coatings means that UV coated synthetic labels also fail to economically meet all the needs of the packaged goods manufacturer.

An example of a poly/poly label is a lightweight clear polypropylene film laminated to a lightweight white opaque polypropylene film printing stock. The clear polypropylene film provides an attractive high gloss appearance and excellent durability for scuff protection and passing drop tests. The 100% film nature of the construction provides the label with 100% waterproof properties. Poly/poly labels, produced in cut and stack form, have been dusted with an offset powder and treated with antistat to prevent sticking and ensure proper feeding of the labels by the labeling equipment. Such an approach ensures smooth label feeding at high operating speeds and has been the industry standard for at least twenty years.

Unfortunately, such an approach has many significant drawbacks. More specifically, the powder is very fine and tends to become entrained in the air currents generated by the equipment during the printing, cutting and labeling operations. As a result, a dusting of fine offset powder settles on operating machines and all equipment. The powder penetrates the circuit boxes, clogs gas jets in dryers and represents a significant maintenance concern and expense. The label making equipment, electrical boxes and entire work area must be periodically cleaned. The offset powder also subjects label application equipment to the same maintenance concerns and needs.

The present invention relates to polymer labels made from laminated polymer materials wherein an antistat and/or a slip agent in the film prevents sticking and ensures proper label feeding in the absence of an offset powder. By eliminating the use of offset powder in the labeling process, equipment maintenance costs are greatly reduced and working conditions are greatly enhanced. In addition, the labels of the present invention offer an enhanced clarity of print in the absence of offset powder and antistat. Further, such an approach eliminates the need to coat a label surface with an antistat and/or a slip agent. The elimination of a processing step streamlines and simplifies the labeling process. This elimination of a processing step streamlines and simplifies the labeling process.

### SUMMARY OF THE INVENTION

In order to achieve the foregoing and in accordance with the purposes of the present invention as described herein, an improved label is provided comprising a first polymer sheet constructed from a polymer film incorporating an additive selected from a group consisting of a slip agent, an antistat and mixtures thereof, a clear film constructed from a polymer incorporating an additive selected from a group consisting of a slip agent, an antistat and mixtures thereof and printing on a face of one of the first polymer sheet and the clear film wherein the first polymer sheet and clear polymer film are laminated together so as to cover and protect the printing. The polymer in the polymer film of the first sheet is selected from a group consisting of polypropylene, polyethylene, polystyrene, vinyl, polyethylene terephthalate, polyester, cavitated with biaxially oriented polypropylene (BOPP), clear BOPP, saran polyethylene terephthalate, saran nylon cello, cello polypropylene, metalized polypropylene, cast polypropylene, and mixtures thereof.

The polymer of the clear film is selected from a group consisting of polypropylene, polyethylene, polystyrene, polyvinyl chloride, polyethylene terephthalate, polytetrafluoroethylene chloride, polyester, nylon and mixtures thereof.

In one possible embodiment the first polymer sheet only incorporates an antistat and the clear film only incorporates a slip agent. In another possible embodiment the first polymer sheet only incorporates a slip agent and the clear film only incorporates an antistat. In yet another embodiment, both the first polymer sheet and clear film incorporate both an antistat and a slip agent. In any of the embodiments the first polymer sheet has a thickness of between about 1.0 and about 4.0 mils. The clear film has a thickness of between about 1.0 and about 4.0 mils. In addition an adhesive may be provided between the first polymer sheet and the clear film. Further, in one particularly useful embodiment the polymer used in the first polymer sheet and the clear film is polypropylene.

In the following description there is shown and described several preferred embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain certain principles of the invention.

FIG. 1 is a schematical edge elevational view of a first embodiment of a label constructed in accordance with the teachings of the present invention;

FIG. 2 is an illustration similar to FIG. 1 but relating to an alternative embodiment; and

FIG. 3 is an illustration similar to FIGS. 1 and 2 relating to yet another alternative embodiment.

Reference will now be made in detail to the present preferred embodiments of the invention, examples of which are illustrated in the accompanying drawings.

### DETAILED DESCRIPTION OF THE INVENTION

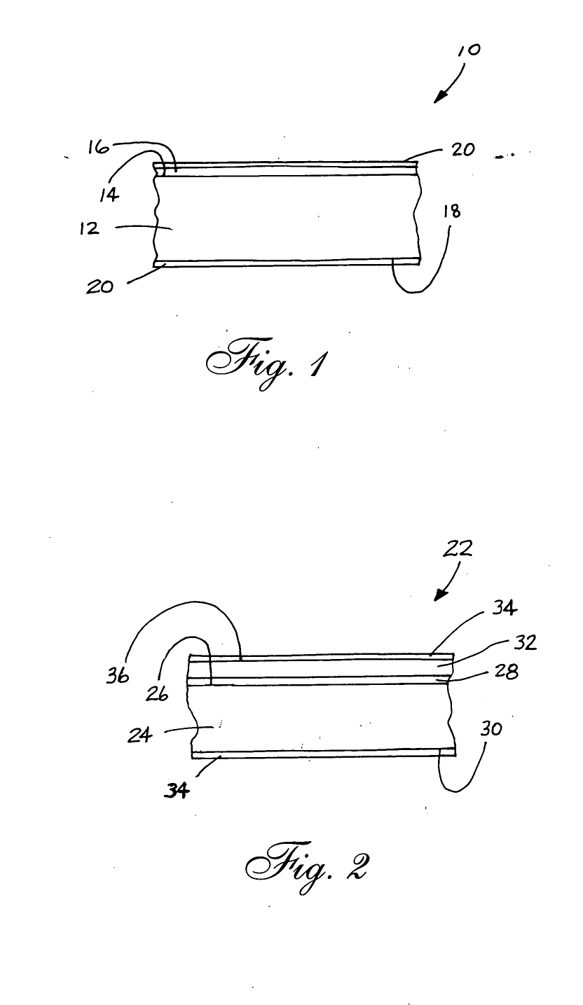

Reference is now made to drawing FIG. 1 clearly illustrating a first embodiment of the label 10 of the present invention. That label 10 comprises a sheet or layer of printing stock 12 having a first face 14 printed with ink or other appropriate material 16 and a second, opposite face 18. A coating 20 of an antistatic formulation is provided over both the first face 14, including the printing 16, and the second, opposite face 18.

A second possible embodiment of the present invention is illustrated in FIG. 2. The label 22 of this embodiment comprises a first layer or sheet of printing stock 24 having a first face 26 printed with an ink or other appropriate material 28. As shown the printing stock 24 also includes a second, opposite face 30. A clear polymer film 32 is laminated to the first, printed face 26 of the printing stock 24. A coating 34 of an antistatic formulation is provided over the face 30 and the exposed face 36 of the clear polymer film 32.

In yet another embodiment also shown in FIG. 2, instead of printing the first face 26 of the printing stock 24, a face of the clear polymer film 32 is printed with ink or other appropriate material 28. That printed face of the clear polymer film is then laminated to a second layer 24 of printing stock, polymer film or any appropriate label making material. The exposed faces 30 and 36 are coated with an antistatic formulation 34.

In any of the above embodiments, the printing stock 12 and 24 may be constructed from a material selected from a group consisting of polymer film, polypropylene, polyethylene, polystyrene, vinyl, polyethylene terephthalate, polyester, cavitated white BOPP (such as sold under the trademark AmTopp-PW or AmTopp-PL by Inteplast Group, LTD), clear BOPP (such as sold under the trademark AmTopp-TL by Inteplast Group, LTD), saran polyethylene terephthalate, saran nylon cello, cello polypropylene, metalized polypropylene, cast polypropylene, metalized paper, metalized foil and mixtures thereof. Preferably the printing stock 12 or 24 has a thickness of at least 0.5 mil and more typically between 0.5 mil-4.0 mil in order to provide the necessary stiffness to allow the label 10 or 22 to be used in existing labeling equipment. The printing stock 12 and/or 24 may be opaque, translucent or transparent. The printing stock 12 or 24 may be white, black or substantially any other color that might be desired by a product manufacturer or packager.

In order to produce the label 22 illustrated in FIG. 2, a clear drying adhesive is applied to the printed face 26 of the printing stock 24 and/or the back side of the clear polymer film 32 and the clear polymer film is laminated to the printing stock by the adhesive. One appropriate adhesive useful for this purpose is product number 14995, a UV laminating adhesive manufactured by Northwest Coatings of Oak Creek, Wis. Of course, other appropriate adhesives are well known in the art. Typically the adhesive is applied at the rate of one pound of adhesive per about 250,000 to about 450,000 sq in of surface area and more typically at a rate of about one pound of adhesive per 320,000 sq in of surface area.

The clear polymer film 32 may be made from any appropriate material including but not limited to polypropylene, polyethylene, polystyrene, polyvinyl chloride, polyethylene terephthalate, polytetrafluroethylene, polyvinyledene fluoride, polyvinyledene chloride, polyester, nylon and mixtures thereof. Typically the clear polymer film 32 is provided in a thickness of between about 0.5 mil to about 4.0 mil. Together, the polymer film printing stock 24 and the clear polymer film 32 are of a sufficient thickness and strength to provide the necessary strength and stiffness to support application in existing labeling equipment. Additionally, the clear polymer film 32 provides the desired durability and scuff protection to protect the printing 38 on the face 26 of the printing stock 24 or any printing present on the rear face of the clear polymer film 32 from damage during packaging, shipping, sale and use by the consumer.

The antistatic formulation used in the coatings 20 and 34 has a formulation comprising from about 2.0% to about 6.0% anti-static agent (e.g. ARMAK 1019, available from Akzo Nobel Surface Chemistry, LLC of Chicago, Ill.), 0-3.0% slip agent/wax (e.g. PBI-19559, available from Flint Ink of Atlanta, Ga.), 0-0.3% defoamer (e.g. Tego Foamex 1435, available from Tego Chemie Service GmbH of Essen, Germany) and the remainder is solvent. This solvent may be selected from a group consisting of water, alcohol and any mixture thereof. A typical alcohol utilized as a solvent in an antistatic formulation of the type being described is isopropyl alcohol. Typically the antistatic formulation is applied at a rate of one pound of antistatic formulation to between about 480,000 sq in to about 900,000 sq in of surface area and more typically at a rate of about one pound of antistatic formulation to about 598,000 sq in of surface area.

By coating both of the exposed faces of the label 10 or 22 with the antistatic formulation, the label is provided with sufficient lubricating and antistatic properties to allow ready separation of stacked labels in existing cut and stack labeling equipment. Specifically, the labels 10 and/or 22 have the necessary stiffness and antistatic properties to avoid sticking together and operate smoothly, efficiently and reliably in existing labeling equipment. Further the labels beneficially provide the properties desired by the packaged goods manufacturers utilizing plastic containers. The labels are 100% waterproof, extremely durable by being resistant to scuffing and product deterioration and able to withstand drops of six feet or more without tearing, and are aesthetically pleasing to the consumer's eye and touch for the foreseeable useful life of the container. Further, the labels 10 and 22 may be manufactured in a cost effective manner competitive in today's marketplace.

As an additional advantage the labels 10 and 22 accomplish these goals without using any offset powder and antistat. This aspect of the invention achieves a number of additional benefits. Specifically, in the absence of the offset powder the labels exhibit better color sharpness and an increase in gloss. Further by eliminating the use of offset powder, the label manufacturer and label applier no longer need to spend significant production downtime and employee labor cleaning offset powder from the label handling equipment as well as the electrical boxes and other areas of the workplace. Further, by eliminating offset powder from the environment, the workplace is made significantly cleaner and more worker-friendly.

A method of producing labels as illustrated in FIG. 1 from a printing stock in accordance with the present invention may, for example, be generally described as including the steps of: (a) printing a first face 14 of the printing stock 12 and (b) coating the first face and the second face 18 with an antistatic formulation.

A method of producing labels as illustrated in FIG. 2 from a printing stock may be generally described as including the steps of (a) printing a first face 26 of the printing stock 24 or a face of the clear polymer film 32, (b) laminating the clear polymer film 32 to the first face 26 of the printing stock and (c) coating the exposed faces of the label 22 with an antistatic formulation. Individual labels may be subsequently cut from the web to provide cut and stack labels.

More specifically describing the production method of the embodiment illustrated in FIG. 2, pre-press steps include making the printing plates, printing inks and selecting the printing stock.

The printing press steps include feeding the printing stock into the printing press. Specifically, as is known in the art, the printing press is composed of a feeding unit for feeding stock into the press, a number of print units and a delivery unit for delivering printed stock out of the press. Each print unit consists of (a) a number of printing cylinders for feeding the printing stock through the press, for applying ink to the printing plate and for transferring ink to the front face of the stock and/or the back side of the clear polymer film and (b) a drying and/or curing unit that dries the ink, coating or adhesive utilizing either hot air drying or ultraviolet curing.

At the first and each subsequent printing unit, ink of a particular color may be applied to the first or print face 26 of the printing stock 24 or the back side of the clear polymer film 32 utilizing the printing plate. Through the application of ink at each printing unit, the printed image of the label is created.

At the last printing unit, an ultraviolet activated adhesive is applied with a rubber roller to the first face 26 of the printing stock 24 over the printed image 28. The printing stock 24 is then nipped to a web of clear polymer film that is fed into the printing press for laminating to the printing stock. Following the nip, an ultraviolet lamp cures the ultraviolet adhesive through the clear film 32 while the printing stock 24 moves over a chilling roll to control the temperature of the stock.

The laminated web is then fed through an antistatic formulation applicator to provide a coating 34 of antistatic formulation over the upper or front face 36 and the lower or rear face 30 of the laminated web. The application may be made by a doctor blade system, a sprayer, a roller, a combination of the above or any other appropriate means. After application, the coating 34 is dried by forced gas drying, electric heat, forced air, a combination of the above or other appropriate means.

Next, the laminated printing stock is delivered, still in web form into a delivery unit. For cut and stack labels, the delivery unit cuts the stock into individual sheets with multiple labels 22 on each sheet. These sheets are then delivered onto a series of skids. Each skid of sheets moves to a post-press for final finishing of the label. Alternatively, the sheets could be fed directly into a finishing operation.

The post-press steps of the manufacturing process require each skid of sheets to be jogged, inspected, separated, cut, banded into individual stacks of a specific quantity of labels and packaged in a box. After jogging, the specified lift of sheets is transferred via air tables or other means to a cutting machine that cuts the sheets into bundles of individual labels 22. After the cutting machine, the bundle of individual labels 22, now in cut and stack form, are packaged and placed in a box for storage and shipment. A bundle of labels 22 can be packaged in a number of ways including banded, string tied or shrink wrapped.

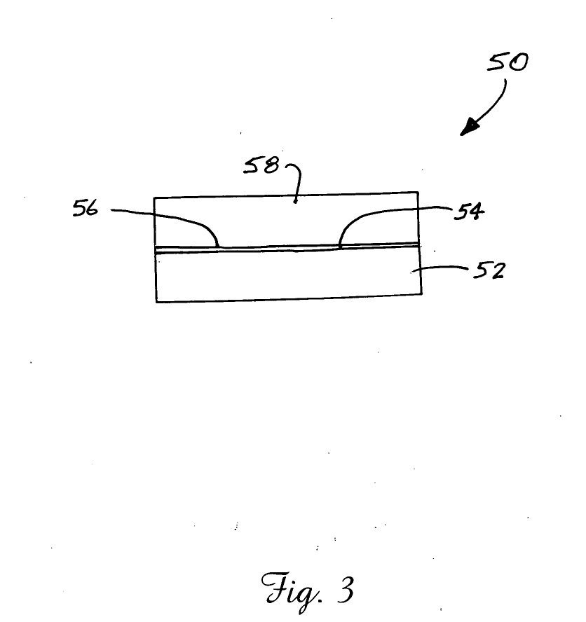

In accordance with yet another embodiment of the present invention, FIG. 3 shows a laminated label 50. That label 50 comprises a polymer sheet or layer of printing stock 52 having a first face 54 printed with ink or other appropriate material 56 and a second sheet or layer 58 of clear polymer film.

The sheet or layer of printing stock 52 may be constructed from a polymer material selected from a group consisting of polypropylene, polyethylene, polystyrene, vinyl, polyethylene terephthalate, polyester, cavitated white BOPP, clear BOPP, saran nylon cello, cello polypropylene, metalized polypropylene, cast polypropylene and mixtures thereof incorporating an additive selected from a group consisting of a slip agent, an antistat and mixtures thereof. Appropriate antistats and slip agents for use with labels to prevent sticking and provide for proper label feeding are well known in the art. Preferably the printing stock 52 has a thickness of at least about 1.0 mil and more typically between about 1.0 to about 4.0 mils. The printing stock 52 may be opaque, transluscent or transparent. The printing stock 52 may be white, black or substantially any other color that might be desired by a product manufacturer or packager.

In order to produce the label 50 illustrated in FIG. 3, a clear drying adhesive is applied to the printed face 54 of the printing stock 52 and/or the back side of the clear polymer film 58 and the clear polymer film is laminated to the printing stock by the adhesive. One appropriate adhesive useful for this purpose is product number 14995, a UV laminating adhesive manufactured by Northwest Coatings of Oak Creek, Wis. Of course, other appropriate adhesives are well known in the art. Typically the adhesive is applied at the rate of one pound of adhesive per about 250,000 to about 450,000 sq in of surface area and more typically at a rate of about one pound of adhesive per 320,000 sq in of surface area.

In one possible embodiment, both of the laminated layers 52, 58 of the label 50 incorporate both slip agent and antistat, although they do not have to be the same slip agent and the same antistat in each layer. Further, more than one slip agent and more than one antistat may be used. In another possible embodiment, the printing stock layer 52 incorporates only antistat while the clear polymer film layer 58 incorporates only slip agent. In yet another embodiment, the printing stock layer 52 incorporates only slip agent while the clear polymer film layer incorporates only antistat. By incorporating both slip agent and antistat into the actual material from which the layers 52, 58 of the label 50 are constructed, there is no need to provide a separate coating of either slip agent and/or antistat to the laminated label 50 thereby eliminating these additional steps in the labeling process. Further, there is no need to dust the label with any type of offset powder.

One possible material that may be used for the printing stock layer 52 is PL40 available from Inteplast Group, Ltd. One possible material that may be used for the clear polymer film layer 58 is TA-40 available from Inteplast Group, Ltd. These materials have been used in the past in packaging but have never been laminated together and used for the production of labels as taught in this document.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A label, comprising:
a first polymer sheet constructed from a polymer film incorporating an additive selected from a group consisting of a slip agent, an antistat and mixtures thereof;
a clear film constructed from a polymer incorporating an additive selected from a group consisting of a slip agent, an antistat and mixtures thereof; and
printing on a face of one of said first polymer sheet and said clear film;
wherein said first polymer sheet and said clear film are laminated together so as to cover and protect said printing.

2. The label of claim 1 wherein said polymer in said polymer film of said first sheet is selected from a group consisting of polypropylene, polyethylene, polystyrene, vinyl, polyethylene terephthalate, polyester, cavitated white BOPP, clear BOPP, saran polyethylene terephthalate, saran nylon cello, cello polypropylene, metalized polypropylene, cast polypropylene and mixtures thereof.

3. The label of claim 1 wherein said polymer of said clear film is selected from a group consisting of polypropylene, polyethylene, polystyrene, polyvinyl chloride, polyethylene terephthalate, polytetrafluoroethylene, polyvinyledene fluoride, polyvinyledene chloride, polyester, nylon and mixtures thereof.

4. The label of claim 1, wherein said first polymer sheet only incorporates an antistat and said clear film only incorporates a slip agent.

5. The label of claim 1, wherein said first polymer sheet only incorporates a slip agent and said clear film only incorporates an antistat.

6. The label of claim 1, wherein said first polymer sheet and said clear film both incorporate a slip agent and an antistat.

7. The label of claim 1, wherein said first polymer sheet has a thickness of between about 1.0 and about 4.0 mils.

8. The label of claim 1, wherein said clear film has a thickness of between about 1.0 and about 4.0 mils.

9. The label of claim 1, including an adhesive between said first polymer sheet and said clear film.

10. The label of claim 1, wherein said polymer used in said first polymer sheet and said clear film is polypropylene.
